(19) United States
(12) Patent Application Publication
(10) Pub. No.: US 2025/0386298 A1
(43) Pub. Date: Dec. 18, 2025

(54) METHOD, DEVICE, AND SYSTEM FOR PAGING LP-WUS CAPABLE UE

(71) Applicant: ZTE Corporation, Shenzhen (CN)

(72) Inventors: Zhuang LIU, Shenzhen (CN); Zijiang MA, Shenzhen (CN); Xiubin SHA, Shenzhen (CN); Li NIU, Shenzhen (CN); Dapeng LI, Shenzhen (CN); Yin GAO, Shenzhen (CN)

(73) Assignee: ZTE Corporation, Shenzhen (CN)

(21) Appl. No.: 19/267,169

(22) Filed: Jul. 11, 2025

Related U.S. Application Data
(63) Continuation of application No. PCT/CN2023/105118, filed on Jun. 30, 2023.

(51) Int. Cl. H04W 52/02; H04W 68/02

(52) U.S. Cl. CPC H04W 52/0235; H04W 68/02

(57) ABSTRACT

This disclosure relates generally to a method, device, and system for congestion control in a wireless network. One method performed by a first network element is disclosed. The method may include receiving, from a second network element or a wireless device, a first message carrying Lower-Power Wake Up Signal (LP-WUS) assistance information associated with the wireless device, the LP-WUS assistance information being indicative of a paging information for paging the wireless device; and determining the paging information based on the LP-WUS assistance information.

### TECHNICAL FIELD

This disclosure is directed generally to wireless communications, and particularly to a method, device, and system for paging a User Equipment (UE) in a wireless network.

### BACKGROUND

Controlling power consumption and reducing energy cost is critical for developing and deploying a wireless communication network. Energy saving technology is critical for achieving this goal. With the development of wireless communication technology, more and more wireless devices and user equipments are powered by small foot print batteries such as small rechargeable and single coin cell batteries. Therefore, it is critical to have the capability to control the power consumption at various network elements, such as UE and base station, and yet still meet performance requirement.

### SUMMARY

The present disclosure relates to methods, devices, and systems for paging UEs (e.g., UEs supporting Lower-Power Wake Up Signal (LP-WUS)) in a wireless network.

In some embodiments, a method performed by a first network element is disclosed. The method may include: receiving, from a second network element or a wireless device, a first message carrying Lower-Power Wake Up Signal (LP-WUS) assistance information associated with the wireless device, the LP-WUS assistance information being indicative of a paging information for paging the wireless device; and determining the paging information based on the LP-WUS assistance information.

In some embodiments, a method performed by a wireless device is disclosed. The method may include: transmitting, to a first network element, a first message carrying Lower-Power Wake Up Signal (LP-WUS) assistance information associated with the wireless device, the LP-WUS assistance information being indicative of a paging information for paging the wireless device, wherein the LP-WUS assistance information comprises at least one of: an indication of whether LP-WUS is supported by the wireless device; an indication of whether LP-WUS is preferred to be activated for the wireless device; an indication of whether LP-WUS is only applied in last serving cell of the wireless device; a ramp-up time indicating how long it takes the wireless device to wake up from an ultra-deep sleep mode; an LP-WUS subgroup identifier indicating an LP-WUS subgroup of the wireless device, the wireless device monitoring an LP-WUS based on the LP-WUS subgroup, the LP-WUS being used for waking up the wireless device; or a paging subgroup identifier indicating a paging subgroup of the wireless device.

In some embodiments, there is a network element or a wireless device comprising a processor and a memory, wherein the processor is configured to read code from the memory and implement any methods recited in any of the embodiments.

In some embodiments, a computer program product comprising a computer-readable program medium code stored thereupon, the code, when executed by a processor, causing the processor to implement any method recited in any of the embodiments.

The above embodiments and other aspects and alternatives of their implementations are described in greater detail in the drawings, the descriptions, and the claims below.

### BRIEF DESCRIPTION OF THE DRAWINGS

FIG. 1 shows an example wireless communication network.

FIG. 2 shows an example wireless network node.

FIG. 3 shows an example user equipment.

FIG. 4 shows an exemplary paging scenario in which core network provides LP-WUS assistance information.

FIG. 5 shows another exemplary paging scenario in which core network provides LP-WUS assistance information.

FIG. 6 shows an exemplary paging scenario in which UE provides LP-WUS assistance information to base station.

FIG. 7 shows exemplary message flow for exchanging, updating LP-WUS assistance information among various network elements for UE in inactive state or UE in idle state.

FIG. 8 shows an exemplary XnAP RAN paging scenario in which LP-WUS assistance information is sent from one base station to another.

FIG. 9 shows an exemplary F1AP RAN paging scenario in which LP-WUS assistance information is sent from CU to DU.

### DETAILED DESCRIPTION

### Wireless Communication Network

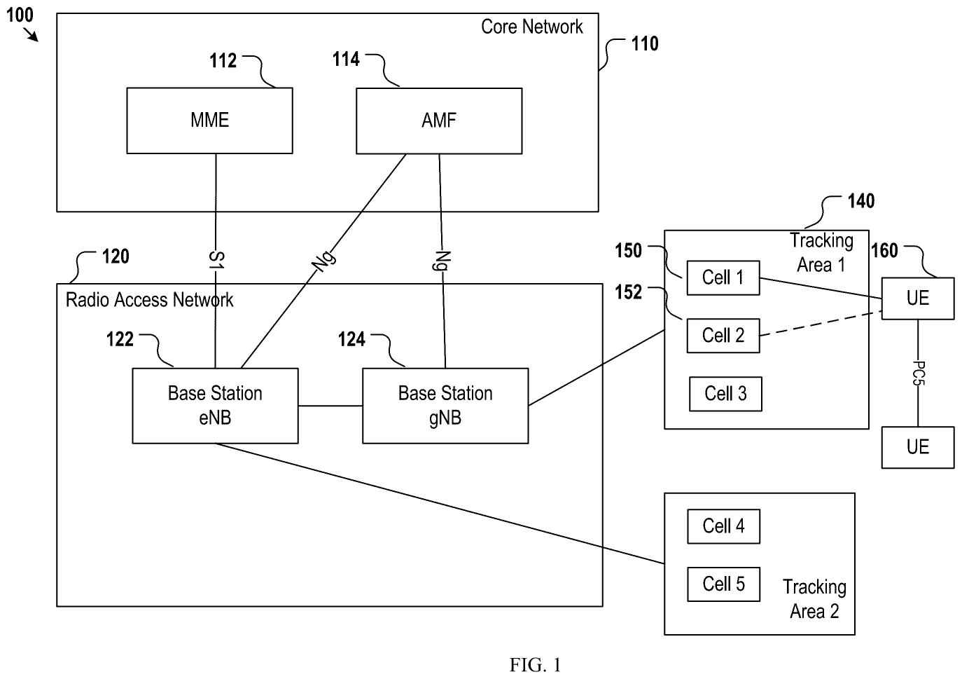

FIG. 1 shows an exemplary wireless communication network 100 that includes a core network 110 and a radio access network (RAN) 120. The core network 110 further includes at least one Mobility Management Entity (MME) 112 and/or at least one Access and Mobility Management Function (AMF). Other functions that may be included in the core network 110 are not shown in FIG. 1. The RAN 120 further includes multiple base stations, for example, base stations 122 and 124. The base stations may include at least one evolved NodeB (eNB) for 4G LTE, an enhanced LTE eNB (ng-eNB), or a Next generation NodeB (gNB) for 5G New Radio (NR), or any other type of signal transmitting/receiving device such as a UMTS NodeB. The eNB 122 communicates with the MME 112 via an S1 interface. Both the eNB 122 and gNB 124 may connect to the AMF 114 via an Ng interface. Each base station manages and supports at least one cell. For example, the base station gNB 124 may be configured to manage and support cell 1, cell 2, and cell 3.

The gNB 124 may include a central unit (CU) and at least one distributed unit (DU). The CU and the DU may be co-located in a same location, or they may be split in different locations. The CU and the DU may be connected via an F1 interface. Alternatively, for an eNB which is capable of connecting to the 5G network, it may also be similarly divided into a CU and at least one DU, referred to as ng-eNB-CU and ng-eNB-DU, respectively. The ng-eNB-CU and the ng-eNB-DU may be connected via a W1 interface.

The wireless communication network 100 may include one or more tracking areas.

A tracking area may include a set of cells managed by at least one base station. For example, tracking area 1 labeled as 140 includes cell 1, cell 2, and cell 3, and may further include more cells that may be managed by other base stations and not shown in FIG. 1. The wireless communication network 100 may also include at least one UE 160. The UE may select a cell among multiple cells supported by a base station to communication with the base station through Over the Air (OTA) radio communication interfaces and resources, and when the UE 160 travels in the wireless communication network 100, it may reselect a cell for communications. For example, the UE 160 may initially select cell 1 to communicate with base station 124, and it may then reselect cell 2 at certain later time point. The cell selection or reselection by the UE 160 may be based on wireless signal strength/quality in the various cells and other factors.

The wireless communication network 100 may be implemented as, for example, a 2G, 3G, 4G/LTE, or 5G cellular communication network. Correspondingly, the base stations 122 and 124 may be implemented as a 2G base station, a 3G NodeB, an LTE eNB, or a 5G NR gNB. The UE 160 may be implemented as mobile or fixed communication devices which are capable of accessing the wireless communication network 100. The UE 160 may include but is not limited to mobile phones, laptop computers, tablets, personal digital assistants, wearable devices, Internet of Things (IoT) devices, MTC/eMTC devices, distributed remote sensor devices, roadside assistant equipment, XR devices, and desktop computers. The UE 160 may also be generally referred to as a wireless communication device, or a wireless terminal. The UE 160 may support sidelink communication to another UE via a PC5 interface.

While the description below focuses on cellular wireless communication systems as shown in FIG. 1, the underlying principles are applicable to other types of wireless communication systems for paging wireless devices. These other wireless systems may include but are not limited to Wi-Fi, Bluetooth, ZigBee, and WiMax networks.

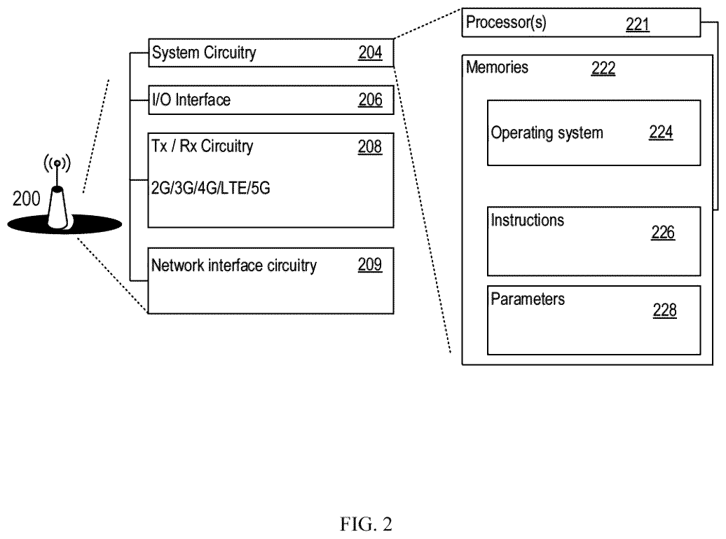

FIG. 2 shows an example of electronic device 200 to implement a network base station (e.g., a radio access network node), a core network (CN), and/or an operation and maintenance (OAM). Optionally in one implementation, the example electronic device 200 may include radio transmitting/receiving (Tx/Rx) circuitry 208 to transmit/receive communication with UEs and/or other base stations. Optionally in one implementation, the electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 221 to perform the functions of the network node. The parameters 228 may include parameters to support execution of the instructions 226. For example, parameters may include network protocol settings, bandwidth parameters, radio frequency mapping assignments, and/or other parameters.

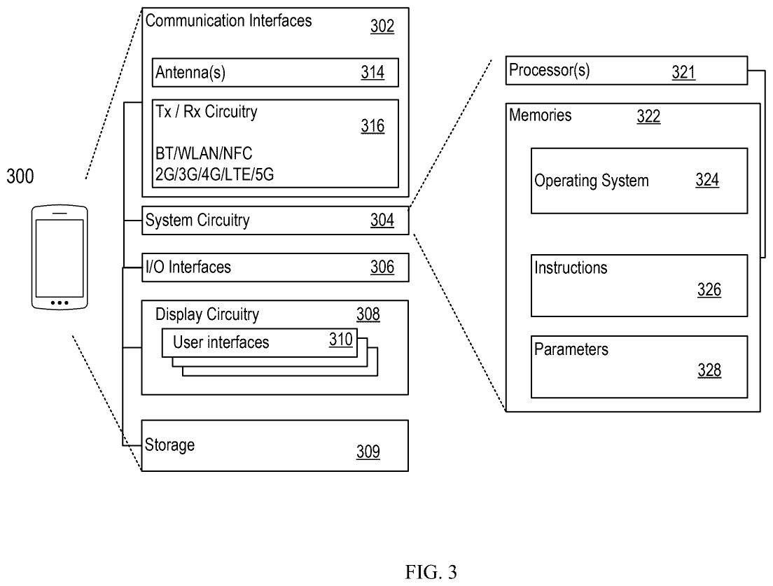

FIG. 3 shows an example of an electronic device to implement a terminal device 300 (for example, a user equipment (UE)). The UE 300 may be a mobile device, for example, a smart phone or a mobile communication module disposed in a vehicle. The UE 300 may include a portion or all of the following: communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), and 5G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G or other data that the UE 300 will send, or has received, through the communication interfaces 302. In various implementations, a system power for the UE 300 may be supplied by a power storage device, such as a battery or a transformer.

### Lower-Power Wake Up Signal (LP-WUS) and LP-WUS Capable UE

In a wireless communication network, a UE may always listen/monitor the network (e.g., a base station such as a gNodeB) to check if there is new downlink data pending transmission.

Energy efficiency has always been a critical factor when designing various wireless devices and/or base stations. With more and more use cases introduced, energy efficiency becomes more critical, especially for UEs without a continuous energy source, for example, UEs using small rechargeable and single coin cell batteries. In vertical use cases, sensors and actuators are deployed extensively for monitoring, measuring, charging/billing, etc. Generally, the batteries in these devices are not rechargeable and are expected to last at least a few years. Additionally, for wearables devices including smart watches, rings, eHealth related devices, and medical monitoring devices, it is typically required that their battery capacity to be able to sustain up to 1-2 weeks, which is a challenge.

The power consumption depends largely on the length of device wake-up period. The length may be configured, for example, by a paging cycle. In each paging cycle, the device may wake up once to monitor paging request. The device will become active if it is paged, otherwise it will go back to sleep mode for energy saving. When the device is active, hardware components such as radio frequency (RF) circuitries, RF chains, RF modules, are turn on to receive/transmit data (e.g., signaling, payload data). In example implementations, to meet the battery life requirements as described above, Discontinuous Reception (DRX) mode, or extended DRX (eDRX) mode with larger cycle than DRX cycle may be used. In DRX mode or eDRX mode, a UE may need to periodically wake up to monitor the paging signaling once per DRX/eDRX cycle, which dominates the power consumption in periods with no paging signaling or data traffic. That is, for most of the time, the UE may wake up only to find there are no pending tasks (e.g., paging, pending data, etc.) and then go back to sleep again. If the UE is able to wake up only when it is triggered (e.g., by an external signal) or when it is needed, for example, when the UE needs to be paged or when there is pending data for the UE, power consumption could be dramatically reduced. In this case, the wake up of the UE may be referred to as trigger based wake up, or need based wake up, compared to the unconditional wake up that is required in each cycle (e.g., DRX/eDRX cycle, paging cycle).

In some example implementations, to achieve the aforementioned trigger based wake up or need based wake up, a multi-level sleep mechanism may be implemented. In such mechanism, a UE may be designed with a Main Radio (MR) (or main radio unit, main radio chain) that handles normal signaling (e.g., paging signaling) and/or data (e.g., uplink data or downlink data), as well as a separate receiver which has the ability to monitor Wake-Up Signal (WUS). The WUS serves as the external triggering signal sent from the network (e.g., a base station) to wake up the UE. Compared with the main radio, the separate receiver is lightweight and requires very little energy to operate. With such design, the UE may enter an ultra-deep sleep mode by shutting down its main radio, but only use the separate lightweight receiver to receive the Wake-Up Signal. The WUS is used as a trigger to cause the UE to turn on its main radio in order to perform subsequent tasks, such as receiving paging signaling, receiving data, etc. When UE is operating in ultra-deep sleep mode, by only operating the lightweight receiver to receive the trigger signal, ultra-low power consumption on the UE may be achieved.

In some example implementations, in ultra-deep sleep mode, the UE may turn off or shut down the main radio to reduce power consumption and does not periodically monitor the legacy paging signal. Instead, the UE may use a separate receiver featuring ultra-low power consumption to monitor a wake-up signal sent from the network. Only if the wake-up signal is detected, the UE will turn on the main radio periodically, to monitor the paging signal. For example, the UE may turn on its main radio per DRX cycle, or per eDRX cycle. Therefore, as far as there is no wake-up signal detected, the UE's main radio may be turned off for a long, extended period, resulting in a dramatic reduction in power consumption. In contrast, in normal sleep mode (that is not ultra-deep sleep mode), even when the UE turns off the radio or main radio, it still must turn on the radio or main radio periodically to monitor the paging signal (e.g., per DRX cycle, per eDRX cycle). This results in an increase in power consumption.

If a UE is equipped with the aforementioned separate receiver which has the ability to monitor the wake-up signal when UE is in ultra-deep sleep mode with ultra-low power consumption, the UE may be referred to as a Lower-Power Wake Up Signal (LP-WUS) capable UE or simply LP-WUS UE. In general, the LP-WUS UE is equipped with a main radio, and a separate receiver to monitor a trigger signal. The separate receiver is lightweight featuring ultra-low power consumption, and is able to operate separately when the main radio is in sleep mode and is turned off. Note that the trigger signal is preferred to be lightweight as well and it should require minimum power and effort to detect.

In Radio Resource Control (RRC) idle state, RRC inactive state, or other inactive state or idle state, an LP-WUS UE may enter an ultra-deep sleep mode for power saving. In the ultra-deep sleep mode, the UE will turn off the Main radio (MR), and monitor the LP-WUS sent by network with a separate lower power consumption radio receiver.

For an LP-WUS capable UE, if the UE has detected an LP-WUS signal (e.g., by using the separate lightweight receiver), the UE may need to take some time to wake up from the ultra-deep sleep mode in order to monitor the subsequent signaling, such as a paging signaling. This period of time is called ramp-up time. The ramp-up time may be considered as the delay from receiving the trigger signal (e.g., LP-WUS) till the main radio is operative/active. The ramp-up time may be determined by, or associated with, how fast the UE reacts to the triggering signal, and/or how fast the UE is able to turn on its main radio and bring the main radio into operative/active state.

To take advantage of the ultra-deep sleep mode, not only a UE needs to be LP-WUS capable, but also coordination is needed between the LP-WUS capable UE and the network (e.g., base station, core network). For example, when an LP-WUS capable UE is in RRC idle state, RRC inactive state, or other inactive/idle state, the UE may enter the ultra-deep mode. At this time, if the network needs to page this UE, the network may not know whether the UE is a legacy UE or an LP-WUS capable UE, and the network may not be able to decide whether it is necessary to first send a wake-up signal to UE and then page the UE, or directly page the UE, resulting in a delay or even failure to page the UE.

The network may take advantage of UE's support on LP-WUS by using LP-WUS paging. Compared to traditional paging, where the network may send a paging signal to the UE directly, and without a need to wake up the UE, the LP-WUS paging may be considered as a 2-step process: in the first step, the network may need to send a triggering signal (e.g., LP-WUS) to wake up the UE, so the UE may turn on its main radio; in the second step, the network proceed to send a paging signal to the UE, and the UE may use its main radio to receive the paging signal. Note that the second step is performed with a delay after the first step, mainly because the network needs to make sure the UE's main radio is ready to receive paging signal. On the UE side, when UE is in LP-WUS paging mode, when the UE is in idle or inactive state, the UE may enter an ultra-deep sleep mode, and only needs to monitor an LP-WUS. The monitoring of LP-WUS may be periodic. Only when the UE is triggered by the LP-WUS, it will wake up to receive a paging signal.

In this disclosure, various embodiments are described aiming to support and take advantage of LP-WUS capable UE in a network. The support may include coordination between the LP-WUS UE and the network. Unless otherwise specified, wake up signal in this disclosure refers to LP-WUS.

Note that embodiments in this disclosure are for exemplary purpose only. Description for an embodiment may include multiple steps and a corresponding method may include all steps, or just a portion of all the steps. Additional steps are not excluded from the method unless it is explicitly stated. Different embodiments and steps in each embodiment may be combined in any order, if there is no conflict.

Details on these embodiments are described below.

### Embodiment 1: Core Network Provides LP-WUS Assistance Information

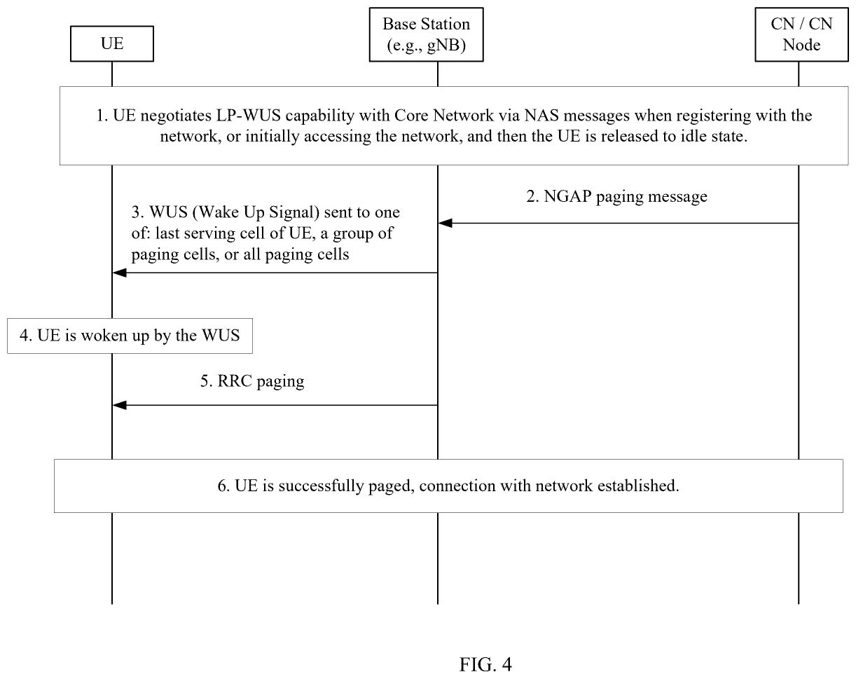

In this embodiment, the Core Network (CN) (or a particular core network node) is in charge of passing/providing the LP-WUS assistance information of a UE to a base station, such as a gNodeB (gNB). Specifically, the CN may pass the LP-WUS assistance information during an NGAP paging procedure. FIG. 4 shows an exemplary message flow for a method according to this embodiment. The method may include a portion or all of the following steps as shown in FIG. 4.

The LP-WUS assistance information may be used by the UE and the network to determine paging information (or paging configuration, paging scheme) that indicates a paging manner. For example, whether LP-WUS paging should be used for paging a UE, or legacy paging should be used (with no LP-WUS). If LP-WUS paging is chosen, the parameters related to LP-WUS paging may be included or indicated by the paging information.

### Step 1:

The LP-WUS capable UE may negotiate LP-WUS capability with the core network through, for example, Non-Access Stratum (NAS) messages. The negotiation may occur when the UE registers with the network, or when the UE attempts initial access to the network. The CN may store the negotiated LP-WUS capability for the UE. After the negotiation, the UE may be released to an idle/inactive state (e.g., RRC idle state, RRC inactive state) at certain time point.

### Step 2:

If the CN needs to page the UE, the CN may determine LP-WUS assistance information based on the negotiated LP-WUS capability for the UE. The CN may then send a paging message to the base station via, for example, an NG interface. The paging message may carry the LP-WUS assistance information. Alternatively, the CN may send the LP-WUS assistance information to the base station using a different message prior to paging the UE.

In some implementations, the LP-WUS assistance information may include, or indicate at least one of the following paging information:
an indication of whether LP-WUS is supported by the UE;
an indication of whether LP-WUS (or LP-WUS paging) is preferred to be activated for the UE;
an indication of whether LP-WUS (or LP-WUS paging) is only applied in last serving cell of the UE;
a ramp-up time, indicates how long it takes UE to wake up from the ultra-deep sleep mode;
an LP-WUS subgroup ID (identifier) indicating the LP-WUS subgroup of the UE; or
a paging subgroup ID indicating the paging subgroup of the UE.

The paging information may be considered as a paging configuration, that may be used by the UE and/or the network to determine a manner on how to page the UE.

In some implementations, the UE may be static that is allocated or arranged in a fixed location. For example, a UE for environment sensing and monitoring. Therefore, it's likely that the last serving cell (in which UE is most recently served) will still serve the UE when the UE is woken up. In this case, LP-WUS paging may only need to apply to the last serving cell. Optionally, in other cells, legacy paging may apply, such that a paging signal/message will be directly sent, without sending an LP-WUS.

In some implementations, in order to further reduce power consumption caused by false paging alarms, UEs may be divided into multiple subgroups. The subgroup may be organized by paging occasions or wake-up signal occasions. UEs in a same paging subgroup (or paging occasion subgroup) will monitor the same paging occasion, and UEs in a same wake-up signal subgroup (or wake-up signal occasion subgroup) will monitor the same wake-up signal occasion. With subgrouping, a UE only needs to monitor its own paging occasion and/or wake-up signal occasion based on the paging subgroup ID or wake-up signal subgroup ID, and does not monitor other paging occasions or wake-up signal occasions that belong to other subgroups.

In some example implementations, the ramp-up time indicates how long it takes UE to wake up from the ultra-deep sleep mode. For example, it may indicate the time interval between UE receiving the LP-WUS signal till the UE turn on its main radio.

In some example implementations, the ramp-up time may be determined by, or may be associated with how long it takes UE to wake up from the ultra-deep sleep mode. For example, the ramp-up time may be a predefined value equal to or greater than the time required for the UE to wake up from the ultra-deep sleep mode.

Note that if the LP-WUS function for a LP-WUS capable UE is activated, UE's main radio is allowed to enter the ultra-deep sleep mode and UE could monitor the LP-WUS signal by using a separate lightweight receiver. Meanwhile, if the LP-WUS for a LP-WUS capable UE is deactivated, UE's main radio is prohibited from entering the ultra-deep sleep mode.

### Step 3:

The base station receives the LP-WUS assistance information sent by the CN, and the base station may page the LP-WUS capable UE based on the LP-WUS assistance information. The base station may determine a manner on how to page the UE. For example, the base station may take at least one of following actions:
(1) If the LP-WUS is not supported by the UE, the base station shall not apply LP-WUS paging to the UE. For example, the base station may not send the wake up signal to the UE. In this case, a traditional paging may be used, that is, the base station may page the UE directly by sending the paging signal (or paging message).
(2) If the LP-WUS is preferred to be activated for the UE, the base station shall apply the LP-WUS paging. That is, the base station may first send the wake up signal to the UE, then page the UE using a paging signal.
(3) In some implementations, the LP-WUS may be only applied in the last serving cell of the UE. The last serving may include the cell that serves the UE most recently. In this case, the base station only sends wake up signal to the UE in last serving cell. In some other implementations, such restriction does not apply and the base station shall send wake up signal to the UE in all paging cells (not only the last serving cell of the UE).
(4) The base station may decide a wait time period to wait before sending a corresponding paging signal after sending the wake-up signal, based on the indicated ramp-up time. This time period reflects a delay for sending the paging signal. This delay is required such that the UE's main radio is turned on so it's ready to receive the paging signal. In some implementations, the delay is at least equal to the UE's ramp-up time.
(5). To further reduce power consumption caused by false paging alarms, UEs may be divided into multiple subgroups. UEs in a same subgroup will monitor the same paging occasion or wake-up signal occasion. With subgrouping, a UE only needs to monitor its own paging occasion and/or wake-up signal occasion based on the paging subgroup ID or wake-up signal subgroup ID, and does not monitor other paging occasions or wake-up signal occasions that belong to other subgroups. The base station may determine a paging subgroup for the UE, or a wake up signal subgroup for the UE, based on the LP-WUS subgroup ID, or the paging subgroup ID. If the LP-WUS subgroup ID is not present in the LP-WUS assistance information, the base station may determine the LP-WUS subgroup for the UE on its own. If the paging subgroup ID is not present in the LP-WUS assistance information, the base station may determine the paging subgroup for the UE on its own.

In the case that LP-WUS is preferred to be activated for the UE, the base station may send the wake up signal to the UE in the last serving cell or in all paging cells.

### Step 4:

The UE is wakened up after the wait time period (e.g., UE's main radio is now operative/active), and starts monitoring the paging signal from the network (e.g., base station).

### Step 5:

The base station sends a paging message (e.g., RRC paging message) to the UE in paging cell(s).

### Step 6:

The UE is successfully paged and subsequently establishes its connection with the network.

### Embodiment 2: Core Network Provides LP-WUS Assistance Information

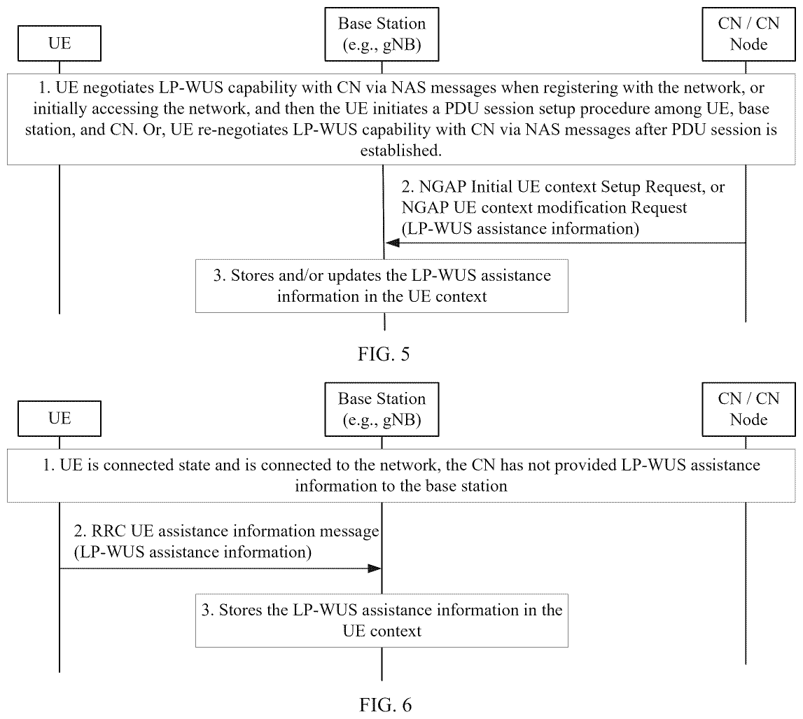

In this embodiment, the Core Network (CN) (or a particular core network node) is in charge of passing/providing the LP-WUS assistance information to a base station, such as a gNodeB (gNB). Specifically, the CN may pass the LP-WUS assistance information during a UE context setup/modification procedure, so the base station may create or modify LP-WUS assistance information. The base station will store the newly created or modified LP-WUS assistance information locally. FIG. 5 shows an exemplary message flow for a method according to this embodiment. The method may include a portion or all of the following steps as shown in FIG. 5.

### Step 1:

The LP-WUS capable UE may negotiate LP-WUS capability with the core network through, for example, NAS messages. The negotiation may occur when the UE registers with the network, or when the UE attempts initial access to the network. Then the UE may initiate a Protocol Data Unit (PDU) session setup procedure among UE, base station, and CN.

Additionally or alternatively, if there is already a PDU session established for the UE, UE may re-negotiate LP-WUS capability with the core network through, for example, NAS messages.

### Step 2:

In the case that the UE context has not been setup yet for the UE, the CN may request UE context setup with the base station by sending, for example, an NGAP initial UE context setup request message to the base station. The NGAP initial UE context setup request message may carry the LP-WUS assistance information. The LP-WUS assistance information is defined in the same way as in embodiment 1.

### Step 3:

The base station stores the LP-WUS assistance information carried in the initial UE context setup request message for the UE.

In some implementations, the LP-WUS assistance information stored by the base station may be updated by, for example, the CN. For example, if the UE context has already been setup for the UE, and/or the PDU session for the UE has already been established, the UE may re-negotiate the relevant LP-WUS capability with the Core Network (CN) through, for example, an NAS message. After the re-negotiation, the LP-WUS assistance information is updated in the CN side. The CN may further need to update the LP-WUS assistance information stored in RAN network. This may be achieved by the CN sending a UE context modification request message to the base station. The UE context modification request message may carry the updated LP-WUS assistance information.

In case the base station receives the updated LP-WUS assistance information carried in, for example, the UE context modification request message, the base station may update its stored LP-WUS assistance information accordingly. For example, the base station may update the UE context in which the LP-WUS assistance information is stored.

### Embodiment 3: UE Provides LP-WUS Assistance Information

In this embodiment, the UE is in charge of passing/providing the LP-WUS assistance information to a base station, such as a gNodeB (gNB). Specifically, the UE may be in a connected or active state, and may already have a connection with the base station. FIG. 6 shows an exemplary message flow for a method according to this embodiment. The method may include a portion or all of the following steps as shown in FIG. 6.

### Step 1:

The UE is in a connected state or active state (e.g., RRC CONNECTED state), and is connected with the network. The core network has not provided LP-WUS assistance information to the base station.

### Step 2:

The UE sends a message, for example, an RRC message, such as a UE assistance information message to the base station. The message carries the LP-WUS assistance information. The LP-WUS assistance information is defined in the same way as in embodiment 1.

### Step 3:

The base station stores the LP-WUS assistance information in the UE context.

### Embodiment 4: RAN Optimizes LP-WUS Assistance Information

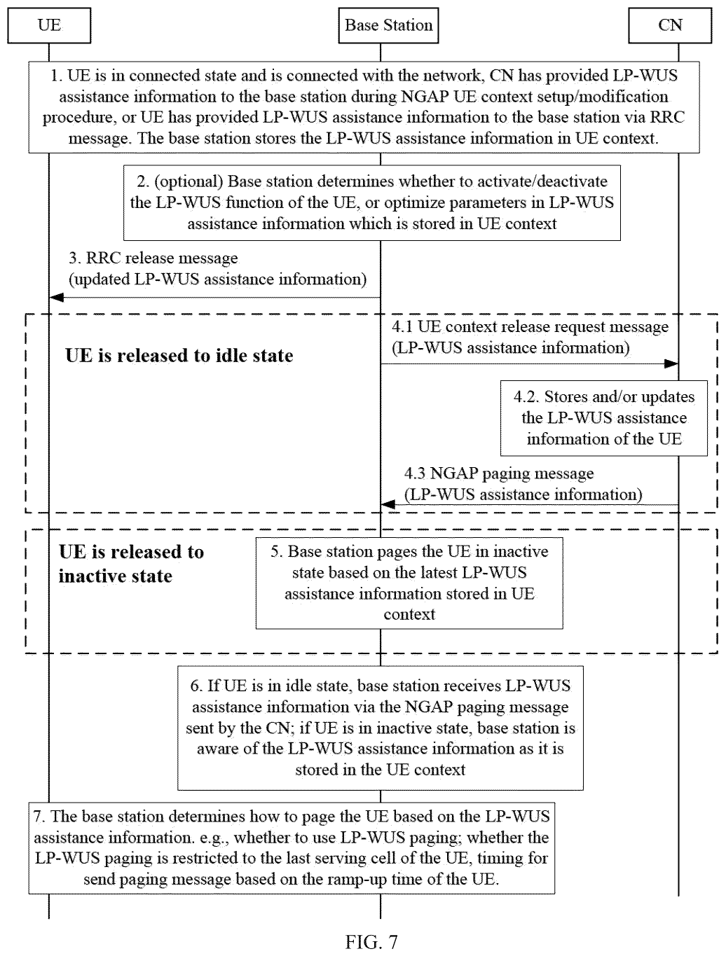

In this embodiment, the Radio Access Network (RAN) such as the base station may further optimize/adjust the LP-WUS assistance information. This embodiment also covers the scenario in which the UE in idle state is paged, and the scenario in which the UE in inactive state is paged. FIG. 7 shows an exemplary message flow for a method according to this embodiment. The method may include a portion or all of the following steps as shown in FIG. 7.

### Step 1:

When the UE is in a connected state or an active state (e.g., RRC CONNECTED state) and is connected to the network, the core network may have provided LP-WUS assistance information to the base station during, for example, the NGAP UE context setup/modification procedure. Alternatively, the UE may have provided LP-WUS assistance information to the base station via, for example, an RRC message. The gNB stores this information in the UE context. The LP-WUS assistance information is defined in the same way as in embodiment 1.

### Step 2:

This step may be optional. Based on the LP-WUS assistance information stored in the UE context, the base station may further optimize/adjust the LP-WUS assistance information, or take further action based on the LP-WUS assistance information.

For example, the base station may determine whether to activate the LP-WUS for the UE, or deactivate the LP-WUS for the UE.

For another example, the base station may determine an optimized ramp-up time for the UE based on cell configuration of the cell that the UE is accessing or camping on. Note that the initial ramp-up time may be determined based on UE's capability, such as how fast the UE may turn on or activate its main radio after receiving the LP-WUS signal, but with no consideration of a cell configuration of the cell that the UE is accessing or camping on. The base station may further adjust/optimized the ramp-up time with cell configuration considered. For example, for paged UEs belonging to the same LP-WUS subgroup or paging subgroup, the cell may want these UEs to be woken up at a same time or about a same time, for example, within a same wake up window, within adjacent wake up windows, in a same occasion in one DRX/eDRX cycle, or in adjacent occasions in one DRX/eDRX cycle, to avoid missing the paging signal. Therefore, the base station may configure a same ramp-up time for these UEs. For another example, for certain type of UEs such as environmental sensor devices, to coordinate or synchronize positioning services or collaborative sensing services using multiple sensors in different UEs, the cell may want these devices to be woken up at a similar or same time and may configure a same ramp-up time for these UEs,. For another example, to reduce paging conflicts or Random Access Channel (RACH) conflicts, the cell may assign a same or different ramp-up time to different UEs to control the UE's access rate. For yet another example for network power saving, the cell may configure different ramp-up time under different power saving mode of the cell to reduce paging frequency.

In some implementations, the cell configuration for optimizing ramp-up time comprises at least one of following: a configured/optimized ramp-up time for a specific service supported by UEs; a configured/optimized ramp-up time for a specific type of UEs; a configured/optimized ramp-up time for a specific wake-up signal subgroup; a configured/optimized ramp-up time for a specific paging subgroup; a configured/optimized ramp-up time for a specific cell power saving mode.

For another example, the base station may determine whether to restrict LP-WUS paging in the last serving cell of the UE. After the decision, the base station will update the stored LP-WUS information in UE context.

In some implementations, the network (e.g., base station, core network) is capable of controlling the utilization of LP-WUS. In other words, only if the network activates the LP-WUS function (or enables the LP-WUS mode) for a LP-WUS capable UE, UE's main radio is allowed to enter into ultra-deep sleep mode and UE could monitor the LP-WUS signal. On the other hand, if the network deactivates LP-WUS for a LP-WUS capable UE, UE's main radio is not allowed to enter the ultra-deep sleep mode for power saving.

### Step 3:

If the base station decides to release the UE to an idle state or inactive state (e.g., RRC idle or RRC inactive state), the base station may send, for example, an RRC release message to the UE. In case the base station has optimized/adjusted the LP-WUS assistance information, the updated LP-WUS assistance information may be carried in this message. When the UE is in the idle or inactive state, the UE shall monitor paging message/signaling based on the received LP-WUS assistance information as following (at least one of the following actions may be performed by the UE):
If LP-WUS is preferred to be activated for the UE, the UE shall turn off (shut down) its main radio, to enter the ultra-deep sleep mode for power saving, and monitor the wake up signal sent by the network;
If LP-WUS is only applied in the last serving cell of the UE (in which the UE is most recently served), then UE only monitors the wake up signal sent by the network in the last serving cell. Otherwise, the UE monitors the wake up signal sent by the network in all cells that the UE accesses or camps (UE's accessing cells or camping cells);
If the UE detects the wake up signal, then the UE shall turn on the main radio and exit the ultra-deep sleep mode before the ramp-up time period expired, and then monitor paging occasions;
If paging subgroup ID is presented or indicated in the LP-WUS assistance information, the UE monitors the paging occasions belonging to, or associated with, the paging subgroup identified by the paging subgroup ID.
If LP-WUS subgroup ID is presented or indicated in the LP-WUS assistance information,, the UE monitors the LP-WUS occasions belonging to, or associated with, the LP-WUS subgroup identified by the LP-WUS subgroup ID

### Step 4:

Step 4 may apply to the case in which the UE is released to the idle state (e.g., RRC idle state).

### Step 4.1:

If the LP-WUS capable UE provided LP-WUS assistance information to the base station, the UE will not negotiate the relevant LP-WUS capability with the CN through NAS messages when registering with the network. In this case, when the base station requests the CN to release UE associated NGAP resource, the base station may add the LP-WUS assistance information in the request message, such as a UE context release message.

If the base station has optimized the LP-WUS assistance information provided by the CN, it may pass the optimized LP-WUS assistance information to the CN when requesting the CN to release UE associated NGAP resource by adding the optimized LP-WUS assistance information in the request message, such as a UE context release message.

### Step 4.2:

The CN stores/updates the LP-WUS assistance information accordingly. The CN shall use the LP-WUS assistance information for subsequent paging of the UE in idle state.

### Step 4.3:

If the CN decides to page the UE in idle state, the CN may send an NGAP paging message to the base station, including the latest LP-WUS assistance information in the message.

Note that when the UE is released to an idle state, the base station may discard the corresponding UE context for the UE.

### Step 5:

Step 5 may apply to the case in which the UE is released to the inactive state (e.g., RRC inactive state). The base station decides to page the UE in inactive state (e.g., RRC inactive state) based on the latest LP-WUS assistance information stored in UE context which is retained in the base station.

### Step 6:

In the case that UE is in idle state, the base station receives LP-WUS assistance information from the NGAP paging message sent by the CN. In the case that the UE is in inactive state, the base station is aware of the LP-WUS assistance information as it is stored in the UE context which is retained in the base station.

### Step 7:

The base station determines how to page the UE based on the LP-WUS assistance information. For example, based on whether LP-WUS paging is restricted to the last serving cell of the UE, the base station may choose to send the WUS signal to the UE in the last serving cell or all paging cells. For another example, if LP-WUS paging is preferred, the base station first sends the WUS signal, then after UE is woken up (which may be measured by the ramp-up time period, or the desired waiting period before sending paging message, see details in embodiment 1), the base station sends the paging message to UE.

### Embodiment 5: RAN Paging from One Base Station via Another Base Station

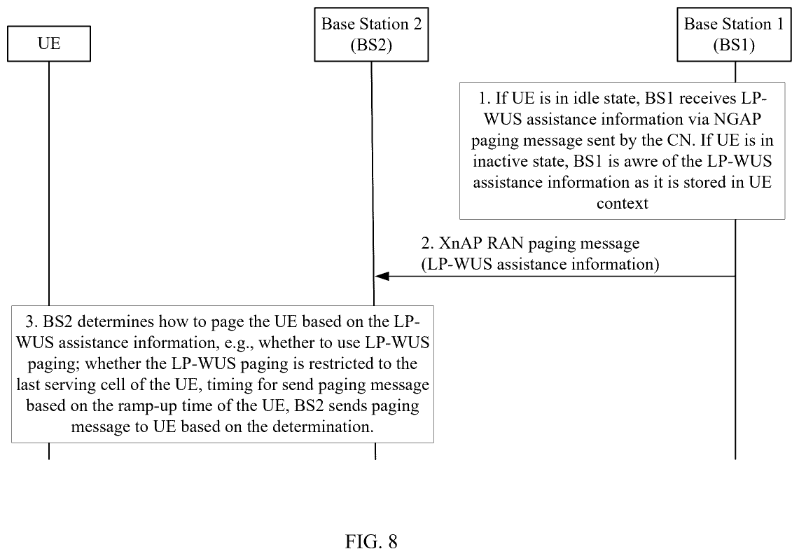

In this embodiment, the RAN paging is used to page a UE. In RAN paging, one base station may page the UE via another base station via, for example, the Xn interface. FIG. 8 shows an exemplary message flow for a method according to this embodiment. The method may include a portion or all of the following steps as shown in FIG. 8.

### Step 1:

If the UE is in an idle state (e.g., RRC idle state), the base station 1 receives LP-WUS assistance information from, for example, the NGAP paging message sent by the CN.

If the UE is in an inactive state (e.g., RRC inactive state), the base station 1 is aware of the LP-WUS assistance information as it is stored in the UE context.

### Step 2:

If the base station decides to page the UE via other base stations, the base station 1 may send a paging message, such as an XnAP RAN paging message to the base station 2. The XnAP RAN paging message may carry the LP-WUS assistance information. Note that the LP-WUS assistance information is defined in the same way as in embodiment 1.

### Step 3:

The base station 2 may determine how to page the UE based on the received LP-WUS assistance information. For example, based on whether LP-WUS paging is restricted to the last serving cell of the UE, the base station 2 may choose to send the WUS signal to the UE in the last serving cell or all paging cells. For another example, if LP-WUS paging is preferred, the base station 2 first sends the WUS signal, then after UE is woken up by the WUS signal (which may be measured by the ramp-up time period, or the desired waiting period before sending paging message, see details in embodiment 1), base station 2 sends the paging message to UE.

### Embodiment 6: F1 Paging via Distributed Unit (DU)

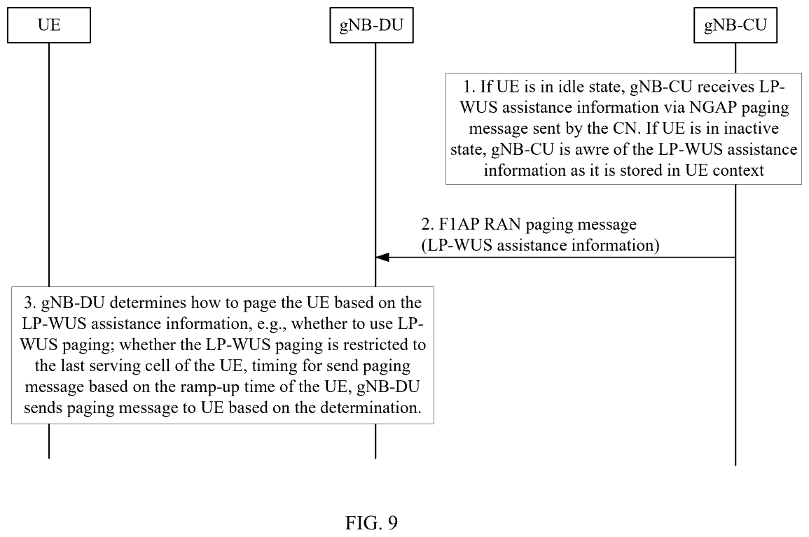

In this embodiment, the base station has a distributed architecture with a Central Unit (CU) and one or more Distributed Units (DUs) which are controlled by the CU. For example, the base station is a gNB, which includes one gNB-CU, and one or more DUs. The F1 paging is used to page a UE. In F1AP paging, the CU triggers the DU to send the paging message/signaling to the UE. FIG. 9 shows an exemplary message flow for a method according to this embodiment. The method may include a portion or all of the following steps as shown in FIG. 9.

### Step 1:

If the UE is in an idle state (e.g., RRC idle state), the gNB-CU receives LP-WUS assistance information from, for example, the NGAP paging message sent by the CN.

If the UE is in an inactive state (e.g., RRC inactive state), the gNB-CU is aware of the LP-WUS assistance information as it is stored in the UE context.

### Step 2:

If the gNB-CU decides to page the UE via gNB-DU(s), the base station 1 may send a paging message, such as an F1AP RAN paging message to the gNB-DU(s). FIG. 9 shows one gNB-DU as an example, but there may be more than one gNB-DU. The F1AP RAN paging message may carry the LP-WUS assistance information. Note that the LP-WUS assistance information is defined in the same way as in embodiment 1.

### Step 3:

The gNB-DU may determine how to page the UE based on the received LP-WUS assistance information. For example, based on whether LP-WUS paging is restricted to the last serving cell of the UE, the gNB-DU may choose to send the WUS signal to the UE in the last serving cell or all paging cells. For another example, if LP-WUS paging is preferred, the gNb-DU first sends the WUS signal, then after UE is woken up by the WUS signal (which may be measured by the ramp-up time period, or the desired waiting period before sending paging message, see details in embodiment 1), gNB-DU sends the paging message to UE.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Embodiments in this disclosure are for exemplary purpose only. Description for an embodiment may include multiple steps and a corresponding method may include all steps, or just a portion of all the steps. Additional steps are not excluded from the method unless it is explicitly stated. Different embodiments and steps in each embodiment may be combined in any order, if there is no conflict.

Furthermore, the described features, advantages and characteristics of the present solution may be combined in any suitable manner in one or more embodiments. One of ordinary skill in the relevant art will recognize, in light of the description herein, that the present solution may be practiced without one or more of the specific features or advantages of a particular embodiment. In other instances, additional features and advantages may be recognized in certain embodiments that may not be present in all embodiments of the present solution.

1. A method for wireless communication, performed by a first network element, the method comprising:
receiving, from a second network element or a wireless device, a first message carrying Lower-Power Wake Up Signal (LP-WUS) assistance information associated with the wireless device, the LP-WUS assistance information being indicative of a paging information for paging the wireless device; and
determining the paging information based on the LP-WUS assistance information.

2. The method of claim 1, wherein the LP-WUS assistance information comprises at least one of:
an indication of whether LP-WUS is supported by the wireless device;
an indication of whether LP-WUS is preferred to be activated for the wireless device;
an indication of whether LP-WUS is only applied in last serving cell of the wireless device;
a ramp-up time indicating how long it takes the wireless device to wake up from an ultra-deep sleep mode;
an LP-WUS subgroup identifier indicating an LP-WUS subgroup of the wireless device, the wireless device monitoring an LP-WUS based on the LP-WUS subgroup, the LP-WUS being used for waking up the wireless device; or
a paging subgroup identifier indicating a paging subgroup of the wireless device.

3. The method of claim 1, wherein:
the second network element comprises a core network node;
the first message comprises at least one of:
an NG Application Protocol (NGAP) initial UE context setup request message for requesting a UE context setup for the wireless device;
an NGAP UE context modification request message for requesting a UE context modification for the wireless device; or
an NGAP paging message for paging the wireless device; and
receiving the first message comprises:
receiving, from the core network node, the first message carrying the LP-WUS assistance information.

4. The method of claim 1, receiving the first message comprises:
receiving, from the wireless device, a Radio Resource Control (RRC) UE assistance information message for reporting information of the wireless device, the RRC UE assistance information message carrying the LP-WUS assistance information.

5. The method of claim 1, further comprising optimizing or modifying the LP-WUS assistance information to obtain updated LP-WUS assistance information, the updated LP-WUS assistance information indicating at least one of:
whether an activation of a LP-WUS mode for the wireless device is needed;
whether a deactivation of the LP-WUS mode for the wireless device is needed;
an optimized ramp-up time for the wireless device based on a cell configuration of a cell that the wireless device accesses or camps on; or
whether LP-WUS paging is restricted in a last serving cell of the wireless device.

6. The method of claim 5, wherein the optimized ramp-up time is determined based on at least one of:
a cell configuration of a cell that the wireless device accesses or camps on;
a power saving mode of the cell that the wireless device accesses or camps on;
a service associated with the wireless device;
a type of the wireless device;
an LP-WUS subgroup that the wireless device belongs to; or
a paging subgroup that the wireless device belongs to.

7. The method of claim 5, further comprising storing the updated LP-WUS assistance information in UE context of the wireless device.

8. The method of claim 5, wherein:
the second network element comprises a core network node; and
the method further comprises:
sending, to the second network element, a second message requesting the second network element to release the wireless device, the second message carrying the updated LP-WUS assistance information.

9. The method of claim 8, wherein the second message comprises a UE context release message.

10. The method of claim 8, wherein:
sending the second message comprises:
sending, to the second network element, the second message requesting the second network element to release the wireless device to an idle state, the second message carrying the updated LP-WUS assistance information; and
the method further comprises:
receiving a paging message from the second network element, the paging message carrying the updated LP-WUS assistance information; and
paging the wireless device based on the updated LP-WUS assistance information.

11. The method of claim 1, wherein the first network element comprises a first base station, the method further comprising:
sending, to a second base station, a paging message carrying the LP-WUS assistance information, the paging message triggering the second base station to page the wireless device based on the LP-WUS assistance information.

12. The method of claim 1, wherein the first network element comprises a Central Unit (CU) of a base station, the method further comprising:
sending, to a Distributes Unit (DU) of the base station, a paging message carrying the LP-WUS assistance information, the paging message triggering the DU to page the wireless device based on the LP-WUS assistance information.

13. The method of claim 1, wherein determining the paging information based on the LP-WUS assistance information comprises at least one of:
in response to the LP-WUS assistance information indicating that the wireless device does not support LP-WUS, determining not to use a LP-WUS paging to page the wireless device;
in response to the LP-WUS assistance information indicating that the LP-WUS paging is preferred by the wireless device, determining to use the LP-WUS paging to page the wireless device;
in response to the LP-WUS assistance information indicating that the LP-WUS paging is restricted to a last serving cell of the wireless device, determining to only use the LP-WUS paging to page the wireless device in the last serving cell, otherwise determining to use the LP-WUS paging to page the wireless device in all paging cells;
determining a waiting period based on the LP-WUS assistance information, and sending a paging message to page the wireless device with a delay after sending a LP-WUS to the wireless device, the delay being equal to or greater than the waiting period;
determining a LP-WUS subgroup that the wireless device belongs to based on the LP-WUS assistance information, the wireless device monitoring the LP-WUS based on the LP-WUS subgroup; or
determining a paging subgroup that the wireless device belongs to based on the LP-WUS assistance information, the wireless device monitoring the paging message based on the paging subgroup.

14. The method of claim 13, wherein the LP-WUS is used to wake up the wireless device by triggering the wireless device to turn in a main radio, and the main radio is used to receive the paging message.

15. The method of claim 5, further comprising:
sending, to the wireless device, a third message triggering the wireless device to transition to an idle or an inactive state, the third message carrying the updated LP-WUS assistance information.

16. The method of claim 15, wherein the third message comprises an RRC release message.

17. The method of claim 1, wherein the first network element comprises a base station, the base station comprising one of:
a gNodeB (gNB);
an eNodeB (eNB);
an ng-eNodeB (ng-eNB); or
a NodeB.

18-28. (canceled)

29. A first network element comprising a memory for storing computer instructions and a processor in communication with the memory, wherein, when the processor executes the computer instructions, the processor is configured to cause the first network element to:
receive, from a second network element or a wireless device, a first message carrying Lower-Power Wake Up Signal (LP-WUS) assistance information associated with the wireless device, the LP-WUS assistance information being indicative of a paging information for paging the wireless device; and
determine the paging information based on the LP-WUS assistance information.

30. The first network element of claim 29, wherein the LP-WUS assistance information comprises at least one of:
an indication of whether LP-WUS is supported by the wireless device;
an indication of whether LP-WUS is preferred to be activated for the wireless device;
an indication of whether LP-WUS is only applied in last serving cell of the wireless device;
a ramp-up time indicating how long it takes the wireless device to wake up from an ultra-deep sleep mode;
an LP-WUS subgroup identifier indicating an LP-WUS subgroup of the wireless device, the wireless device monitoring an LP-WUS based on the LP-WUS subgroup, the LP-WUS being used for waking up the wireless device; or
a paging subgroup identifier indicating a paging subgroup of the wireless device.

31. A non-transitory storage medium for storing computer readable instructions, the computer readable instructions, when executed by a processor in a first network element, causing the processor to:
receive, from a second network element or a wireless device, a first message carrying Lower-Power Wake Up Signal (LP-WUS) assistance information associated with the wireless device, the LP-WUS assistance information being indicative of a paging information for paging the wireless device; and
determine the paging information based on the LP-WUS assistance information.
